(19) United States
(12) Patent Application Publication
(10) Pub. No.: US 2023/0054716 A1
(43) Pub. Date: Feb. 23, 2023

(54) MEMBRANELESS HYDROGEN ELECTROLYZER WITH STATIC ELECTROLYTE

(71) Applicant: X Development LLC, Mountain View, CA (US)

(72) Inventors: Radu Gogoana, Brisbane, CA (US); Matthew Forkin, San Mateo, CA (US)

(21) Appl. No.: 17/728,767

(22) Filed: Apr. 25, 2022

Related U.S. Application Data
(60) Provisional application No. 63/234,519, filed on Aug. 18, 2021.

(51) Int. Cl. C25B 1/04; C25B 9/63; C25B 11/00

(52) U.S. Cl. CPC C25B 1/04; C25B 9/63; C25B 11/00

(57) ABSTRACT

A hydrogen electrolyzer cell includes a shared reservoir, anode and cathode chambers, and a dividing wall. The shared reservoir holds an electrolytic solution. The anode chamber extends up from the shared reservoir and includes an anode electrode for producing oxygen gas during an electrolysis of the electrolytic solution. An oxygen degassing region is integrated into the anode chamber above the anode electrode. The cathode chamber extends up from the shared reservoir and includes a cathode electrode for producing hydrogen gas during the electrolysis. A hydrogen degassing region is integrated into the cathode chamber above the cathode electrode. The dividing wall extends up from the shared reservoir and separates the anode chamber from the cathode chamber. The dividing wall blocks transport of charged ions within the electrolytic solution across the dividing wall and blocks mixing of the hydrogen and oxygen gases released during the electrolysis.

### CROSS-REFERENCE TO RELATED APPLICATIONS

This application claims the benefit of Provisional Application No. 63/234,519, filed Aug. 18, 2021, the contents of which are hereby incorporated by reference.

### TECHNICAL FIELD

This disclosure relates generally to hydrogen electrolyzers, and in particular though not exclusively, to aqueous alkaline electrolysis for the production of hydrogen gas.

### BACKGROUND INFORMATION

The world's energy demands are projected to rise for the foreseeable future. Renewable sources of energy, such as solar and wind will contribute an increasing portion of these future energy needs. Renewable energy sources will be used to charge batteries, which will replace fossil fuels as a significant energy source for many transportation needs, such as automobile transportation. However, batteries may not provide sufficient energy/power densities to satisfy the needs of certain energy intensive transportation applications such as large craft commercial air travel and trans-oceanic trips. Hydrogen and hydrogen fuel cell technologies can provide the necessary energy density to power even these highest energy demand applications. Synthetic fuels made using hydrogen as a feedstock can also target many end use energy needs that are historically difficult to decarbonize. Examples include: high-energy-density fuels required for aviation and shipping, green fuel flexibility for gas turbine power generation, and as a feedstock for various industrial production processes. As such, hydrogen-based technologies include the promise to decarbonize what grid based or battery electrification cannot.

Green technologies (e.g., low net carbon or carbon neutral technologies) for commercial production of hydrogen gas currently require immense capital expenditures. These immense capital expenditures are significant barriers to the broad-based adoption of hydrogen fuel cell technologies and hydrogen-based synthetic fuel. Commercial scale hydrogen solutions that are capable of significantly reducing these capital expenditures, thus providing plentiful hydrogen at an economically competitive price, may hasten the deployment and adoption of green hydrogen-based technologies.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1 is a cross-sectional view illustrating a hydrogen electrolyzer cell, in accordance with an embodiment of the disclosure.

FIG. 2A is a perspective view illustration of a hydrogen electrolyzer stack including five cells stacked in series, in accordance with an embodiment of the disclosure.

FIG. 2B is a perspective view illustration of a hydrogen electrolyzer stack with a side cutout illustrating internal details, in accordance with an embodiment of the disclosure.

FIG. 3 is a perspective exploded view of a modular and extensible panel construction of a hydrogen electrolyzer cell, in accordance with an embodiment of the disclosure.

FIG. 4 is a cross-sectional illustration through a center of the five-cell hydrogen electrolyzer stack, in accordance with an embodiment of the disclosure.

FIG. 5 is a perspective view illustration of an array of stacks of hydrogen electrolyzer cells coupled for large scale hydrogen production, in accordance with an embodiment of the disclosure.

### DETAILED DESCRIPTION

Embodiments of a system, apparatus, and method of operation for a hydrogen electrolyzer cell and cell stack-up are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Embodiments of a hydrogen electrolyzer cell and hydrogen electrolyzer stack described herein provide a low-cost option for generation of hydrogen while only modestly trading off efficiency for substantial capital expenditure (CAPEX) savings. The CAPEX savings are derived, in significant part, from integrating a number of expensive, conventionally distinct components into an extensible structure that may be fabricated of low-cost materials, such as injection molded thermoplastic (e.g., polypropylene). CAPEX savings are also derived from the elimination of components such as gaskets, tie rods, and compression plates that are typically used in alkaline electrolyzers. For example, it is believed that a loss of approximately 10% efficiency may be traded for roughly a 10× reduction in CAPEX when compared against conventional alkaline hydrogen electrolyzers. For commercial scale megawatt electrolyzers, this CAPEX savings may mean the difference between economically viable hydrogen production options and uneconomical options that will not be deployed. The high CAPEX of conventional hydrogen electrolyzers often requires that they operate 24/7 with little down time to achieve economic viability. In these scenarios, the use of intermittent green power generation (e.g., solar or wind power) may be precluded and thus the low or zero carbon benefit of hydrogen fuel cells and hydrogen-based synthetic fuels compared to traditional fossil fuels may be reduced or even entirely lost. In contrast, the low cost, scalable nature of the embodiments described herein is expected to be more viable for use with these intermittent green power sources.

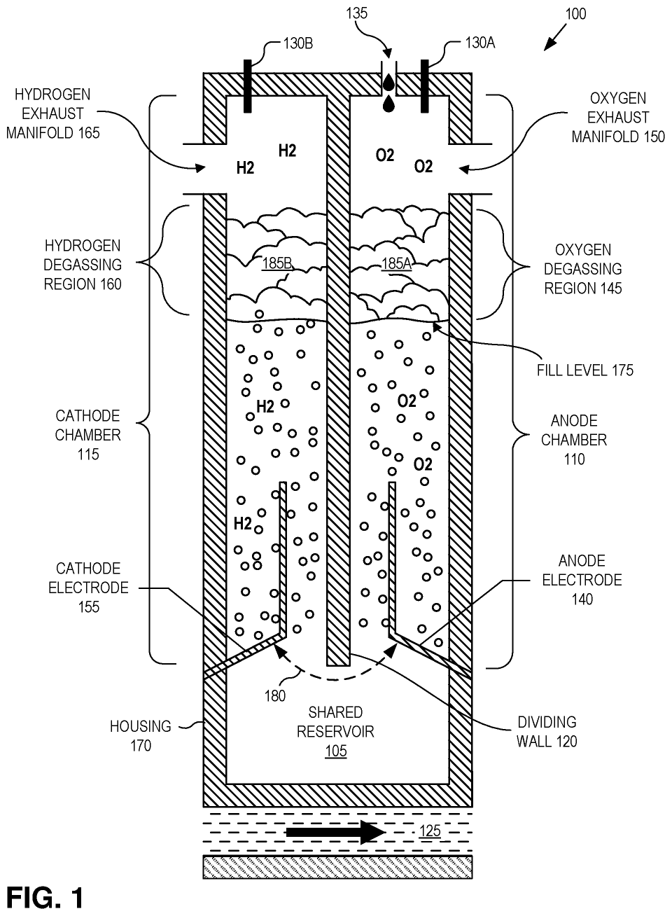

FIG. 1 illustrates a hydrogen electrolyzer cell 100, in accordance with an embodiment of the disclosure. The illustrated embodiment of cell 100 includes a shared reservoir 105, an anode chamber 110 separated from a cathode chamber 115 by a dividing wall 120, a heat exchange path 125, gas sensors 130A and 130B, and a de-ionized (DI) water injection port 135. The illustrated embodiment of anode chamber 110 includes anode electrode 140, oxygen degassing region 145, and oxygen exhaust manifold 150. The illustrated embodiment of cathode chamber 115 includes cathode electrode 155, hydrogen degassing region 160, and hydrogen exhaust manifold 165. In the illustrated embodiment, a modular and extensible housing 170, which includes dividing wall 120, defines and encloses shared reservoir 105, anode chamber 110, cathode chamber 115, and heat exchange path 125. In other embodiments, heat exchange path 125 may be entirely omitted in favor of exterior surface convective cooling using liquid or gaseous coolants. For example, air may be blown across one or more (or all) exterior surfaces of housing 170 instead of integrating interior heat exchange path 125 within housing 170.

In one embodiment, the bulk of housing 170 is fabricated of an inexpensive, monolithic material. For example, housing 170 may be an injection molded thermoplastic (e.g., polypropylene). Of course other materials, compounds, or a combination of materials may be used depending upon a particular application. For example, housing 170 may be fabricated using a multilayer laminate construction combining multiple different materials having various desirable properties for heat resistance, mechanical strength, corrosion resistance, and/or thermal conductivity. Furthermore, housing 170 may be modular, meaning that it is assembled from multiple pieces, and extensible, meaning that it is formed from a repeating structure that facilities stacking multiple instances of the single cell 100 to increase hydrogen production. In one embodiment, the sidewalls and dividing wall 120 are approximately 1 mm thick polypropylene. Of course, other thickness may be used. Not only is monolithic construction from thermoplastic inexpensive, but the metal electrodes and plastic housing bodies may be reconditioned or recycled to further reduce the lifetime cost. Reconditioning may be achieved via in-situ pressurized flushing of the stack with other chemicals.

When deployed, shared reservoir 105, anode chamber 110, and cathode chamber 115 are filled with an electrolytic solution to a fill level 175 that entirely bathes (i.e., submerges) anode electrode 140 and cathode electrode 155 within the electrolytic solution. The electrolytic solution is a stagnant or static bath and need not be pumped, or actively circulated or recycled through the cell or cell stack during electrolysis, though passive convection currents may arise as a side effect of internal heat dissipation or frothing during degassing. In one embodiment, the electrolytic solution is an alkaline solution (base), such as aqueous potassium hydroxide (KOH) having 25% KOH and 75% water. Other electrolytes and/or electrolytic concentrations may be used. The electrolytic solution may include other additives such as antifouling agents or surfactants. The antifouling agents may be used to reduce biofouling, reduce chemical buildup, suppress undesirable side reactions, improve performance, or otherwise. The surfactants may be used to affect the diameter of the hydrogen/oxygen bubbles rising within cathode chamber 115 or anode chamber 110, or otherwise. As the water in the electrolytic solution is consumed during electrolysis, it may be replenished by direction injection of deionized water via DI water injection port 135.

Divider wall 120 extends up from shared reservoir 105 and separates anode chamber 110 from cathode chamber 115. In one embodiment, dividing wall 120 extends equal to or below the bottom of the electrodes 140 and 155 exposed to the electrolytic solution. Dividing wall 120 terminates at the top of shared reservoir 105 to permit transport of charged ions within the electrolytic solution under dividing wall 120 through shared reservoir 105 along conduction path 180 between anode electrode 140 and cathode electrode 155. In one embodiment, the height of shared reservoir 105 below dividing wall 120 is approximately equal to the width of each of anode chamber 110 and cathode chamber 115. Of course, other dimensions may be implemented. Dividing wall 120 is a solid non-permeable wall that blocks transport of charged ions forcing the conduction path 180 down around its distal/bottom end. Similarly, dividing wall 120 blocks mixing of the hydrogen and oxygen gases released during electrolysis. During operation, the oxygen and hydrogen gases bubble up in their respective chambers forming froths 185A and 185B (collectively referred to as froth 185) in oxygen degassing region 145 and hydrogen degassing region 160, respectively. The vertical orientation of anode chamber 110 and cathode chamber 115 facilitates this passive, buoyancy-driven separation of the oxygen and hydrogen gases during electrolysis. The integrated degassing regions significantly reduces the need for expensive external phase separators/demisters that are corrosion resistant. The height of degassing regions may be selected to ensure froth 185 does not spill over into exhaust manifolds 150 and 165 for a desired operational drive current. If froth 185 does spill over into either exhaust manifold 150 or 165, a shunting current path may be established degrading performance and may contaminate the exhaust manifolds and connecting plumbing with the caustic electrolytic solution.

Embodiments of hydrogen electrolyzer cell 100 operate without need of expensive catalysts or membranes disposed between the electrodes as used in conventional electrolyzers. In the illustrated embodiment, anode electrode 140 and cathode electrode 155 are both fabricated from metal, such as nickel. In one embodiment, anode electrode 140 and cathode electrode 155 are fabricated from a metal mesh, such as a nickel metal mesh. A woven metal mesh, an expanded metal mesh, an expanded metal foam, a metal foil, a perforated metal, an expanded metal foil, nanostructured metal features on a foil, or otherwise may also be used. Anode electrode 140 and cathode electrode 155 may assume a variety of different sizes and shapes, such as metallic foams or other 3-dimensional structures. For example, the surfaces of the electrodes may be roughened to increase overall surface area in contact with the electrolytic solution. In one embodiment, anode electrode 140 and cathode electrode 155 may each be 2 cm long, though the electrodes need not be symmetrical. In yet other embodiments, the distal tips of electrodes may be folded over to keep more surface area of the electrodes closer to the bottom tip of dividing wall 120, thereby reducing the resistance of conduction path 180. Additionally, one or both of electrodes 140 and 155 may include integrated or coated catalysts, such as palladium, iridium, etc.

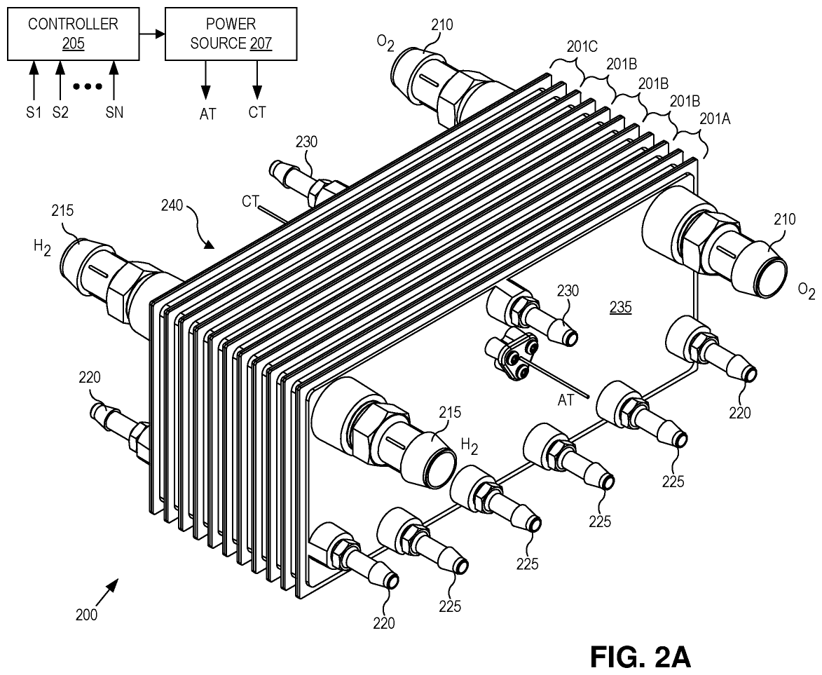

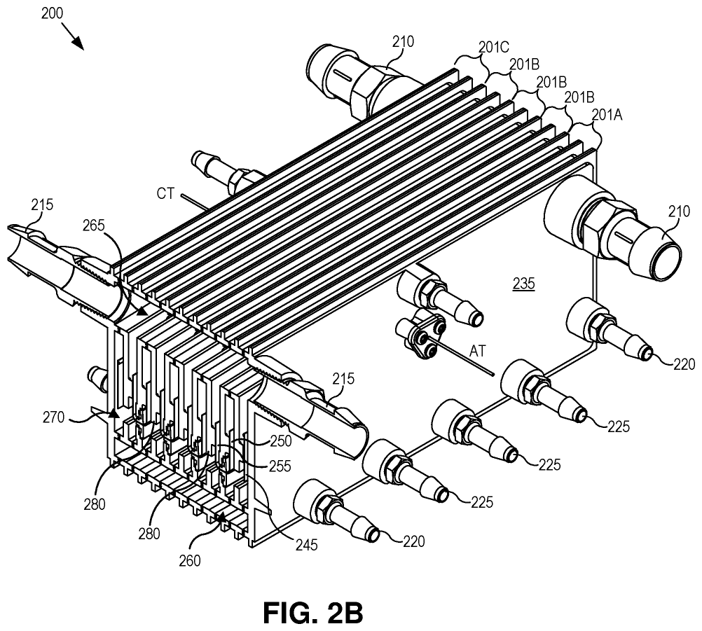

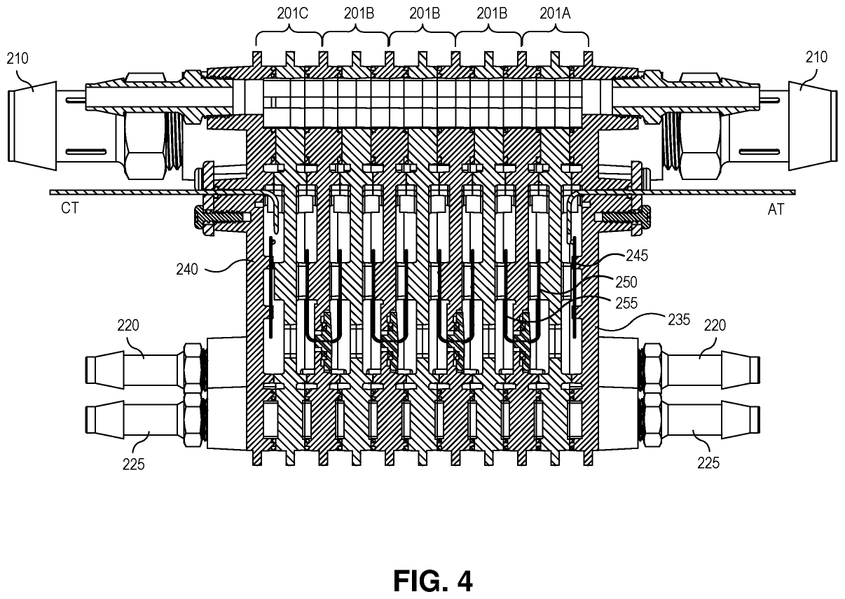

As discussed in more detail below in connection with FIG. 2B and FIG. 4, anode electrode 140 and cathode electrode 155 of adjacent electrolyzer cells in a stack of series connected cells may be implemented as joint electrodes formed from a single contiguous piece of metal (or metal mesh) bent into a U-shape or a V-shape that is embedded in and passes through the sidewall of housing 170. In one embodiment, the sidewalls of housing 170 are over-molded on top of the joint electrodes, to seal and separate the electrolytic solution in adjacent chambers.

As previously mentioned, oxygen exhaust manifold 150 is integrated into anode chamber 110 to export oxygen from cell 100, while hydrogen exhaust manifold 165 is integrated into cathode chamber 115 to export hydrogen gas from cell 100. Both oxygen exhaust manifold 150 and hydrogen exhaust manifold 165 are extensible for coupling to adjacent hydrogen electrolyzer cells in a stack. Again, by integrating the exhaust manifolds into the extensible/modular structure of housing 170 itself, costs associated with stacking large numbers of hydrogen electrolyzer cell 100 are reduced.

Similar to the other extensible components, heat exchange path 125 is also integrated into housing 170 and designed to connect with heat exchange paths 125 of adjacent cells stacked in series. In the illustrated embodiment, heat exchange path 125 is disposed adjacent to (e.g., under) shared reservoir 105 to exchange heat with the electrolytic solution. During regular operation, heat may be carried away from the electrolytic solution via circulating a heat exchange fluid (e.g., a water glycol coolant mixture, other liquid coolants, gaseous coolants, etc.) through heat exchange path 125. During a startup process, the heat exchange fluid may be preheated to a desired startup temperature to aid with startup of the electrolysis. This may be done by a heater within the coolant loop, or alternatively by running the electrolysis process in a deliberately inefficient operating regime, such as by using a higher voltage per cell than normal operation, to generate heat internally for bringing the system up to its optimal operating temperature. In an embodiment wherein housing 170 is fabricated of injection molded thermoplastic, the electrolytic solution may be cooled to maintain an operating temperature of approximately 95 degrees Celsius. This operating temperature is limited by the mechanical properties of the thermoplastic; for example, some thermoplastics that are more expensive than polypropylene can handle higher temperatures before deformation, such as polysulfone. The exhaust manifolds may be operated at atmospheric pressure, or a backpressure applied to elevate the boiling point of the electrolytic solution and operate at higher temperatures and pressures depending upon the material or materials selected to form housing 170. Operating at higher temperatures and/or pressures may increase operating efficiency though may increase the cost of the material selection for housing 170 to withstand these higher temperatures and/or pressures. Pressure regulators may be coupled to the exhaust manifolds to manage gas flows and balance back pressures between the oxygen and hydrogen exhaust manifolds.

In the illustrated embodiment, anode chamber 110 includes a gas sensor 130A and cathode chamber 115 includes a gas sensor 130B adapted to monitor for cross mixing of hydrogen and oxygen gases resulting in a combustible vapor mixture. In one embodiment, gas sensors 130A and 130B are implemented using catalytic gas detectors such as a catalytic pellistor or otherwise. Gas sensors 130A and 130B may be coupled to a controller (e.g., controller 205) configured to shut down and/or automatically purge a contaminated exhaust manifold (e.g., purge with an inert gas) in case a combustible mixture of hydrogen and oxygen is detected, due to unintentional crossover of gas bubbles below dividing wall 120. For cost efficiency reasons, these combustible gas sensors may be placed in the exhaust manifolds at the end of a stack, so that they can monitor for potentially combustible mixtures coming from multiple stacks 200 at once. While FIG. 1 illustrates a set of gas sensors 130A and B for use with the single cell 100, it should be appreciated that in a large stack-ups of cells 100, gas sensors 130A and B may be inserted into the shared exhaust manifolds at the end of a serialized stack and thus shared across many individual cells 100.

FIGS. 2A and 2B illustrate of a hydrogen electrolyzer stack 200 including multiple hydrogen electrolyzer cells 201A, B and C (collectively referred to as cells 201) stacked in series, in accordance with an embodiment of the disclosure. FIG. 2A is a perspective view illustration of stack 200 while FIG. 2B includes a side cutout illustrating internal details of stack 200. Cells 201 each represents one possible implementation of hydrogen electrolyzer cell 100 illustrated in FIG. 1. The illustrated embodiment of stack 200 includes five cells 201, an anode terminal (AT), a cathode terminal (CT), oxygen manifold ports 210, hydrogen manifold ports 215, fill/drain ports 220, heat exchange ports 225, DI water ports 230, anode end panel 235, and cathode end panel 240.

As illustrated, cells 201 may be stacked in series to form stack 200. Although FIGS. 2A and 2B illustrated just five cells 201 coupled in series, it should be appreciated that more or less cells 201 may be stacked in series. The interior cells 201B may be identical, repeatable structures sandwiched between end cells 201A and 201C. The cells 201 may be mechanically connected with fasteners and sealed with gaskets (e.g., o-rings), hot-plate welded to avoid the cost associated mechanical fasteners and gaskets, or connected and sealed using other techniques (e.g. ultrasonic welding, vibration welding, infrared welding, laser welding, etc.) or adhesives.

In one embodiment, a power source 207 is a direct current (DC) to DC converter that couples to CT and AT to apply a bias voltage across the series connected cells 201. Power source 207 may further include various intermittent power sources such as solar cells or wind turbines. A controller 205 is coupled to power source 207 and stack 200. Controller 205 may include hardware and/or software logic and a microprocessor to orchestrate operation of power source 207 and stack 200. In the illustrated embodiment, controller 205 monitors various sensor signals S1, S2 . . . SN from stack 200 and uses these feedback sensor signals to control power source 207. The sensor signals may include temperature readings, gas sensor readings, voltage readings, electrolyte level readings, etc. sourced from stack 200. During regular operation, controller 205 applies a forward bias potential across CT and AT. However, in some instances, controller 205 may periodically, or on-demand, short or reverse bias CT and AT to recondition the anode and cathode electrodes. Short circuiting or reverse biasing may be particularly beneficial for anode electrode 140 due to the buildup of surface layer nickel oxides. Reverse biasing may be at a sufficiently low voltage that does not cause electrolysis and gas production, while still reconditioning the electrodes. Alternatively, the exhaust manifolds may be purged with an inert gas before and after reverse biasing if higher reverse bias potentials are desired, to prevent the buildup of potentially flammable mixtures of oxygen and hydrogen internally. In one embodiment, electromechanical (or fluid) taps may be attached to one side of each manifold port 210 and 215 for selectively injecting an inert purging gas (e.g., nitrogen) into the hydrogen and oxygen exhaust manifolds. Flow through the taps may be electronically controlled under the influence of controller 205. A periodic reconditioning schedule may leverage the diurnal rhythms of intermittent green energy. Of course, commercial scale operations having large banks of stacked cells 201 may implement a staggered reconditioning schedule that takes one or more stacks 200 offline at a time while maintaining operation of the remaining stacks 200. An effective reconditioning schedule will reverse electrode degradation while recovering and/or maintain operating efficiencies over longer durations. The above identified control strategies serve to potentially increase electrode and stack life well beyond conventional electrolyzer lifespans of approximately 7 years. For example, useful lifespans exceeding 20 years may be possible using these control strategies.

Correlating FIG. 2A to FIG. 1, fill/drain ports 220 connect to shared reservoir 105 of cells 201 to fill or drain the electrolytic solution. Heat exchange ports 225 couple to heat exchange path 125 of cells 201 to circulate a heat exchange fluid through stack 200 for temperature regulation. Since heat exchange path 125 is isolated from the caustic electrolytic solution, inexpensive air-to-liquid heat exchangers may be used to circulate and cool the heat exchange fluid. These air-to-liquid heat exchangers may be fabricated of less expensive aluminum as opposed to stainless steel, which is typically used when circulating the electrolytic solution itself. Oxygen manifold ports 210 connect to oxygen exhaust manifold 150 of each cell 201 to export oxygen gas from the stack 200 while hydrogen manifold ports 215 connect to hydrogen exhaust manifold 165 of each cell 201 to export hydrogen gas from stack 200. DI water ports 230 couple to DI water injection port 135 of each cell 201. Finally, cathode terminal CT connects directly to cathode electrode 155 of a first end cell 201C while anode terminal AT connects directly to anode electrode 140 of the other end cell 201A.

FIG. 2B includes a side cutout of hydrogen electrolyzer stack 200 illustrating internal details, in accordance with an embodiment of the disclosure. Anode terminal AT directly connects to anode electrode 245 of end panel 235 of end cell 201A. As illustrated, cathode electrode 250 of end cell 201A and anode electrode 255 of adjacent interior cell 201B form a joint electrode having a U-shape that is embedded in and passes through the shared sidewall between these adjacent cells. Half of the joint electrode is a cathode for end cell 201A while the other half is an anode for the adjacent interior cell 201B. This U-shaped joint electrode is illustrated in greater detail in FIG. 4. Of course, other cross-sectional shapes, such as a V-shape, may be implemented with the joint electrodes.

Returning to FIG. 2B, the heat exchange path of each cell 201 aligns to and joins with the heat exchange path of its adjacent cells to form an extensible heat exchange path 260 that runs the length of stack 200 and connects to heat exchange ports 225. Similarly, the hydrogen exhaust manifold of each cell 201 aligns to and joins with the hydrogen exhaust manifold of its adjacent cells to form an extensible hydrogen exhaust manifold 265 that runs the length of stack 200 and connects to hydrogen manifold ports 215. A similar structure applies to the oxygen exhaust manifold. Shared reservoir 270 is also extensible when adding cells. In one embodiment, equalization ports are formed through sidewalls of the cells 201 to allow the electrolytic solution to be filled via fill/drain ports 220, spread to each cell 201, and fill to a common fill level 175 throughout stack 200. Finally, FIG. 2B further illustrates dividing walls 280 (not all are labelled in FIG. 2B) that extend down to the top of the extensible shared reservoir 270.

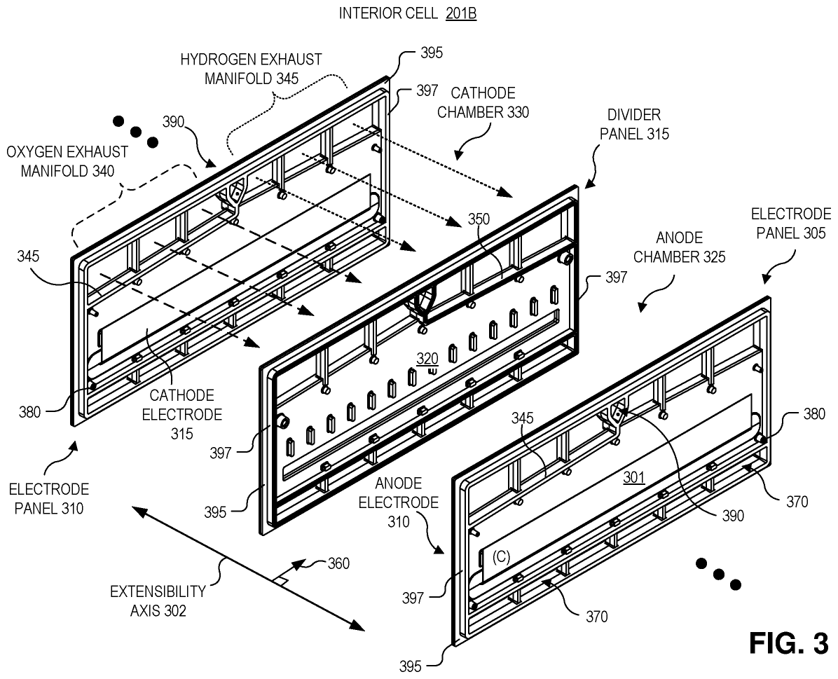

FIG. 3 illustrates how hydrogen electrolyzer cells 201 are extensible and stackable using a modular panel design, in accordance with an embodiment of the disclosure. The housing of interior cell 201B is assembled from two electrode panels 305 and 310 sandwiching a divider panel 315. Since cell 201B is an interior cell, its outer electrode panels 305 and 310 are shared by adjacent cells in stack 200. Multiple interior cells 201B may be stacked on either side of the illustrated interior cell 201B along extensibility axis 302. In other words, cathode electrode 301 is the cathode of an adjacent cell 201 (not illustrated in FIG. 3) while anode electrode 310 (hidden from view) and cathode electrode 315 form the electrodes of the instant interior cell 201B illustrated in FIG. 3. Thus, electrode panels 305 and 310 include embedded joint electrodes while divider panel 315 forms a dividing wall 320 between anode chamber 325 and cathode chamber 330. The joint electrodes may also be referred to as “bipolar electrodes” similar to bipolar plate electrodes used in conventional alkaline electrolyzers where one side of the electrode is negative and the other side is positive.

Electrode panels 305, 310 and divider panel 315 may be fabricated from a variety of materials; however, in one embodiment, they are fabricated from a common material, such as injection molded thermoplastic. The panels may be sealed together to form the housing structure of each cell using gaskets, hot-plate welding, adhesives, or otherwise. The extensibility comes from stacking multiple sets of panels together. In other embodiments, large stacks of cells may be fabricated using a one-step manufacturing process (rather than assembled from a set of pieces). For example, a stack of cells may be cast as a single part, 3D printed, etc. FIG. 3 also illustrates flanges 395 that extend along the perimeter of each electrode panel 305/310 and divider panel 315 and skirt the outer ledges 397. Ledges 397 are the raised locations for sealing adjacent panels using any of the afore mentioned techniques. Flanges 395 provide a structural extension for holding, aligning, and applying mechanical pressure during the assembly and sealing (e.g., hot-plate welding) processes. Ledges 397 may be melted together or include grooves for housing seals (e.g., gaskets, adhesive, etc.). Flanges 395 may also serve a dual purpose of operating as a cooling fin or turbulator to induce turbulent fluid flow over the exterior surfaces of a stack of cells (e.g., stacks 501) when exterior convective cooling is applied.

Electrode panels 305, 310 and divider panel 315 all include oxygen exhaust manifold 340 disposed laterally (along axis 360) to hydrogen exhaust manifold 345. When the panels are sealed together into stack 200, oxygen exhaust manifold 340 and hydrogen exhaust manifold 345 both extend through the entire stack 200. Ridges 345 press against dividing panel 315 sealing oxygen exhaust manifold 340 off from cathode chambers 330 while ridges 350 press against electrode panel 305 sealing hydrogen exhaust manifold 345 off from anode chambers 325. Ridges 345 and 350 alternate from one panel to the next in the stack up to ensure oxygen and hydrogen exhaust gases do not mix between their respective exhaust manifolds.

FIG. 3 further illustrates how heat exchange paths 370 are integrated into panels 305, 310, and 315. Each electrode panel 305 and 310 may further include an electrolyte equalization port 380 connecting one shared reservoir to another shared reservoir of an adjacent cell. These electrolyte equalization ports are passages through electrode panels 305 and 310 in the shared reservoir region to permit passage of the electrolyte solution during filling and draining and to help equalization of fill level 175 across multiple cells 201. To reduce the likelihood of shunt current paths between adjacent shared reservoirs, the electrolyte equalization ports are staggered side-to-side between electrode panels 305 and 310 to introduce a circuitous, high resistance electrical path between adjacent shared reservoirs.

FIG. 3 illustrates DI channel 390 that is formed when sandwiching the panels together. DI channel 390 couples to DI water ports 230 at either end of a stack of panels to replenishing water consumed in each cell during electrolysis and maintain electrolyte concentrations within defined bounds. A DI water injection port 135 may be a hole or embedded tube disposed on an interior surface of each electrode panel 305/310 within DI channel 390, or a notch disposed on a surface edge of each electrode panel 305/310 within DI channel 390. DI water injection ports 135 may share a common DI channel 390, but either feed into only anode chambers 110 or only cathode chambers 115. Including DI water injection ports 135 into both anode and cathode chambers may require separate DI channels 390, one-way values, or another mechanism to prevent combustible mixing of oxygen and hydrogen gases within DI channel 390.

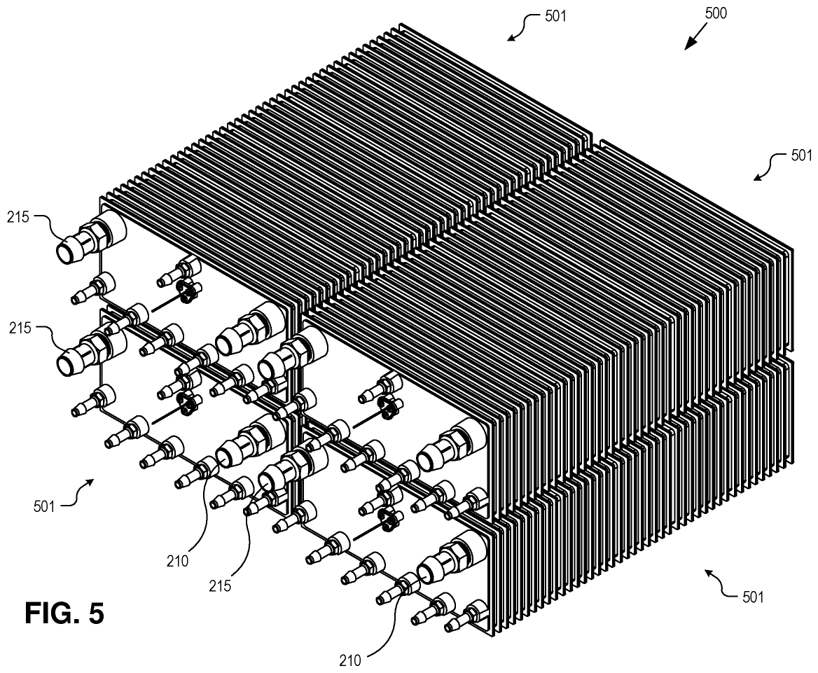

FIG. 5 is a perspective view illustration of an array 500 of stacks 501 of hydrogen electrolyzer cells coupled for large scale hydrogen production, in accordance with an embodiment of the disclosure. For example, a 1 MW electrolyzer array may include approximately 1400 stacks 501 with each stack 501 extending approximately 6 feet long for a total of 200,000 individual cells in the overall array 500. In a large array 500, oxygen manifold ports 210 and hydrogen manifold ports 215 may be connected to large external manifolds (not illustrated) where pressure regulators and gas sensors may be disposed to collectively regulate back pressures and monitor operation of stacks 501.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A hydrogen electrolyzer cell, comprising:
a housing;
a shared reservoir disposed within the housing for holding an electrolytic solution;
an anode chamber disposed within the housing and extending up from the shared reservoir, the anode chamber including an anode electrode for producing oxygen gas during an electrolysis of the electrolytic solution, the anode chamber including an oxygen degassing region integrated into the anode chamber above the anode electrode;
a cathode chamber disposed within the housing and extending up from the shared reservoir, the cathode chamber including a cathode electrode for producing hydrogen gas during the electrolysis of the electrolytic solution, the cathode chamber including a hydrogen degassing region integrated into the cathode chamber above the cathode electrode; and
a dividing wall extending up from the shared reservoir and separating the anode chamber from the cathode chamber, wherein the dividing wall blocks transport of charged ions within electrolytic solution across the dividing wall during the electrolysis and blocks mixing of the hydrogen and oxygen gases released during the electrolysis.

2. The hydrogen electrolyzer cell of claim 1, wherein the shared reservoir extends under both the anode and cathode chambers and the dividing wall terminates at a top of the shared reservoir to permit transport of the charged ions within the electrolytic solution under the dividing wall through the shared reservoir between the anode and cathode electrodes during the electrolysis.

3. The hydrogen electrolyzer cell of claim 2, further comprising the electrolytic solution filling the shared reservoir and partially filling the anode and cathode chambers to a fill level that entirely bathes the anode and cathode electrodes in the electrolytic solution while keeping frothing of the electrolytic solution during the electrolysis within the oxygen and hydrogen degassing regions, wherein the electrolytic solution is not actively circulated during the electrolysis.

4. The hydrogen electrolyzer cell of claim 1, wherein the anode electrode and the cathode electrode both comprise metal meshes.

5. The hydrogen electrolyzer cell of claim 1, wherein the dividing wall extends down past bottoms of the anode and cathode electrodes.

6. The hydrogen electrolyzer cell of claim 1, wherein the housing, which defines the shared reservoir, the anode chamber, and the cathode chamber, and includes the dividing wall integrated into the housing are all fabricated of a common material.

7. The hydrogen electrolyzer cell of claim 6, wherein the common material comprises injection molded thermoplastic.

8. The hydrogen electrolyzer cell of claim 1, wherein the housing comprises a modular structure that is repeatable and extensible to form a hydrogen electrolyzer stack of series connected hydrogen electrolyzer cells including the hydrogen electrolyzer cell.

9. The hydrogen electrolyzer cell of claim 8, further comprising:
an oxygen exhaust manifold integrated into the anode chamber to export the oxygen gas from the anode chamber; and
a hydrogen exhaust manifold integrated into the cathode chamber to export the hydrogen gas from the cathode chamber,
wherein the oxygen and hydrogen exhaust manifolds are extensible for coupling to adjacent hydrogen electrolyzer cells in the hydrogen electrolyzer stack,
wherein the oxygen and hydrogen exhaust manifolds are offset from each other along an axis that is perpendicular to an extensibility axis along which the hydrogen electrolyzer stack is extendible.

10. The hydrogen electrolyzer cell of claim 9, further comprising:
gas sensors disposed in the oxygen and hydrogen exhaust manifolds to monitor for a combustible mixture of the oxygen and hydrogen gases.

11. The hydrogen electrolyzer cell of claim 8, further comprising:
a heat exchange path integrated into the housing adjacent to the shared reservoir, the heat exchange path isolated from the shared reservoir to transport a heat exchange fluid distinct from the electrolytic solution.

12. The hydrogen electrolyzer cell of claim 8, wherein the anode electrode comprises one side of a joint electrode having a U-shape or a V-shape that is shared between the anode electrode and an adjacent cathode electrode of an adjacent cell in the hydrogen electrolyzer stack, wherein the joint electrode is embedded in and passes through the housing.

13. The hydrogen electrolyzer cell of claim 8, further comprising:
electrolyte equalization ports connecting the shared reservoir to adjacent shared reservoirs of adjacent cells in the hydrogen electrolyzer stack, wherein the electrolyte equalization ports are staggered side-to-side to lengthen shunt current paths through the shared reservoir to adjacent cells.

14. The hydrogen electrolyzer cell of claim 1, further comprising:
a de-ionized water injection port disposed in one of the anode or cathode chambers to replenish water to the electrolytic solution lost during the electrolysis.

15. The hydrogen electrolyzer cell of claim 1, further comprising:
a controller configured to periodically or on-demand short the anode and cathode electrodes or apply a reverse bias to the anode and cathode electrodes to recondition one or both of the anode and cathode electrodes.

16. A hydrogen electrolyzer stack, comprising:
a cathode terminal;
an anode terminal; and
a plurality of electrolyzer cells stacked in a series, each of the electrolyzer cells comprising:
a shared reservoir for holding an electrolytic solution;
an anode chamber extending up from the shared reservoir, the anode chamber including an anode electrode for producing oxygen gas during an electrolysis of the electrolytic solution, the anode chamber including an oxygen degassing region integrated into the anode chamber above the anode electrode;
a cathode chamber extending up from the shared reservoir, the cathode chamber including a cathode electrode for producing hydrogen gas during the electrolysis of the electrolytic solution, the cathode chamber including a hydrogen degassing region integrated into the cathode chamber above the cathode electrode; and
a dividing wall extending up from the shared reservoir and separating the anode chamber from the cathode chamber, wherein the dividing wall blocks transport of charged ions within the electrolytic solution across the dividing wall and blocks mixing of the hydrogen and oxygen gases released during the electrolysis,
wherein the cathode terminal is coupled to a first end cathode electrode in the series and the anode terminal is coupled to an opposite end anode electrode in the series.

17. The hydrogen electrolyzer stack of claim 16, wherein interior ones of the electrolyzer cells are each formed from two electrode panels sandwiching a divider panel, each of the two electrode panels is shared between adjacent electrolyzer cells in the series, and the dividing wall is integrated into the divider panel.

18. The hydrogen electrolyzer stack of claim 17, wherein the anode electrode and the cathode electrode of adjacent ones of the electrolyzer cells are formed from a single joint electrode that is embedded in and passes through a shared electrode panel.

19. The hydrogen electrolyzer stack of claim 17, wherein the electrode panels and the divider panel form a housing of each of the electrolyzer cells, and wherein the housing comprises injection molded thermoplastic.

20. The hydrogen electrolyzer stack of claim 19, further comprising:
a heat exchange path integrated into the housing adjacent to the shared reservoir, the heat exchange path isolated from the shared reservoir to transport a heat exchange fluid distinct from the electrolytic solution.

21. The hydrogen electrolyzer stack of claim 16, wherein the shared reservoir extends under both the anode and cathode chambers and the dividing wall terminates at a top of the shared reservoir to permit transport of the charged ions within the electrolytic solution under the dividing wall through the shard reservoir between the anode and cathode electrodes during the electrolysis.

22. The hydrogen electrolyzer stack of claim 16, further comprising:
an oxygen exhaust manifold connecting the anode chamber of each of the electrolyzer cells to export the oxygen gas; and
a hydrogen exhaust manifold connecting into the cathode chamber of each of the electrolyzer cells to export the hydrogen gas,
wherein the oxygen and hydrogen exhaust manifolds are offset from each other along an axis that is perpendicular to an extensibility axis along which the hydrogen electrolyzer stack is extendible.
